(19) United States
(12) Patent Application Publication
(10) Pub. No.: US 2019/0115782 A1
(43) Pub. Date: Apr. 18, 2019

(54) WIRELESS CHARGING SYSTEM

(71) Applicant: Primax Electronics Ltd., Taipei (TW)

(72) Inventor: CHIA-HSIANG TSENG, Taipei (TW)

(21) Appl. No.: 15/865,693

(22) Filed: Jan. 9, 2018

(30) Foreign Application Priority Data
Oct. 13, 2017 (TW) 106135147

(51) Int. Cl. H02J 7/02; H02J 50/12

(52) U.S. Cl. CPC H02J 7/025; H02J 50/12

(57) ABSTRACT

A wireless charging system includes a wireless power transmission device and an electronic device. The wireless power transmission device outputs an electric power. The electronic device includes a power receiving module, a control module and a battery charging module. The power receiving module is in wireless communication with the wireless power transmission device to receive the electric power. The control module is connected with the power receiving module. The battery charging module is connected with the control module. The battery charging module receives the electric power from the control module or issues a power change request to the control module. When the control module receives the power change request, the control module requests the wireless power transmission device to increase the electric power through the power receiving module.

### FIELD OF THE INVENTION

The present invention relates to a charging system, and more particularly to a wireless charging system using a wireless charging technology.

### BACKGROUND OF THE INVENTION

Nowadays, a variety of commercially-available electronic devices are developed toward small size and light weightiness in order to possess the portability. In addition, the electronic devices have touch screens. By inputting commands through the touch screens, the electronic devices can be operated accordingly. For example, the electronic devices include smart phones, tablet computers, personal digital assistants (PDAs), handheld game consoles (e.g. PSP, NDSL and Gameboy series game consoles), or the like.

Due to the portability of the above electronic devices, these electronic devices cannot be connected with a power source at any time. For providing sufficient electric power to the electronic device, a built-in battery is usually installed in the electronic device. The battery is a chargeable battery. Consequently, the chargeable battery of the portable electronic device may be charged by the user in a place with the power socket.

In case that the residual battery capacity of the electronic device is insufficient, the chargeable battery of the portable electronic device may be charged through a connecting wire. A first end of the connecting wire is plugged into the electronic device, and a second end of the connecting wire is plugged into a power source or a mobile bank that is capable of storing electric power. Under this circumstance, the electric power provided by the power source or the mobile bank is transmitted to the electronic device through the connecting wire in order to charge the battery of the electronic device.

However, the applications of the charging process are usually restricted by the length of the connecting wire. For example, during the process of charging the electronic device, the connecting wire usually becomes hindrance from operating the device or arbitrarily moving the electronic device.

With development of a wireless charging technology, a wireless charging system for wirelessly charging the electronic device has been disclosed in order to solve the drawbacks of the wired charging technology of using the connecting wire. FIG. 1 schematically illustrates a conventional wireless charging system. The conventional wireless charging system 1 comprises a wireless power transmission device 11 and an electronic device 12. The wireless power transmission device 11 comprises a main body 110, a power cable 111, a driving module 112, a transmitter coil 113 and a first communication protocol module 114. The electronic device 12 comprises a casing 120, a receiver coil 121, a receiving module 122, a battery (not shown) and a second communication protocol module 123.

The power cable 11 of the conventional wireless power transmission device 11 is exposed outside the main body 10. Consequently, the power cable 11 can be connected with a power source (not shown). The driving module 112 and the transmitter coil 13 are both disposed within the main body 10. In addition, the driving module 112 is connected with the power cable 11 and the transmitter coil 13. When the driving module 112 is driven by the power source, the driving module 112 generates an electric current. When the electric current flows through the transmitter coil 13, magnetic induction or magnetic resonance occurs. In response to the magnetic flux generated through the magnetic induction or the magnetic resonance, the transmitter coil 13 outputs a corresponding electric power. The first communication protocol module 114 of the wireless power transmission device 11 and the second communication protocol module 123 are in communication with each other in order to perform the subsequent wireless charging operation. On the other hand, the receiver coil 21 is disposed within the casing 120 of the conventional electronic device 12 for receiving the electric power from the transmitter coil 113 through the magnetic induction or the magnetic resonance. The battery is connected with the receiving module 122. After the electric power is received by the receiver coil 21, the electric power is stored in the battery so as to be utilized.

Generally, the main body 110 of the conventional wireless power transmission device 11 is designed to have a platform profile. In addition, the volume of the main body 110 of the conventional wireless power transmission device 11 is larger than the casing 120 of the conventional electronic device 12 in order to facilitate the user to place the conventional electronic device 12 thereon. During the process of transmitting the electric power from the conventional wireless power transmission device 11 to the conventional electronic device 12, the receiver coil 121 within the conventional electronic device 12 should be purposely placed at a position near the transmitter coil 113 of the conventional wireless power transmission device 11. That is, for allowing the receiver coil 121 to receive the electric power, the transmitter coil 113 should be aligned with the receiver coil 121 as precisely as possible.

With increasing development of science and technology, the battery capacity of the electronic device is gradually increased and the time period of charging the battery is increased. For saving the time period of charging the battery, a wireless charging system with a fast charging function has been introduced into the market. FIG. 2 is a functional block diagram illustrating the architecture of a conventional wireless charging system with a fast charging function. As shown in FIG. 2, the conventional wireless charging system 2 comprises a wireless power transmission device 21 and an electronic device 22.

The wireless power transmission device 21 comprises a first communication protocol module 211 and a first charging protocol module 212. The function of the first communication protocol module 211 is similar to the first communication protocol module 114 of FIG. 1, and is not redundantly described herein. The first charging protocol module 212 comprises a driving module, a transmitter coil and a charging processor (not shown). The functions of the driving module and the transmitter coil of the first charging protocol module 212 are similar to the functions of the driving module 112 and the transmitter coil 113 of FIG. 1. The first charging protocol module 212 is capable of outputting electric power in a wireless transmission manner.

The electronic device 22 comprises a power receiving module 221, a DC converter 222, a control unit 223 and a battery charging module 224. The power receiving module 221 comprises a second communication protocol module 2211 and a second charging protocol module 2212. The second communication protocol module 2211 is used for detecting the electronic device 22 in the wireless transmission manner. After the second communication protocol module 2211 detects the electronic device 22, the second communication protocol module 2211 is in communication with the first communication protocol module 211. The second charging protocol module 2212 is used for receiving the electric power from the first charging protocol module 212 in the wireless transmission manner. The DC converter 222 is connected with the power receiving module 221, the control unit 223 and the battery charging module 224. After the electric power from the power receiving module 221 is transmitted to the DC converter 222, the voltage value of the electric power is converted into a regulated voltage value by the DC converter 222 under control of the control unit 223. The electric power with the regulated voltage is transmitted to the battery charging module 224. The battery charging module 224 comprises a charging circuit (not shown) and a battery (not shown). After the charging circuit receives the electric power from the DC converter 222, the charging circuit charges the battery. The control unit 223 is used for controlling the DC converter 222 to output the electric power with a specified voltage value.

The operations of the wireless charging system 2 will be described as follows. Firstly, the wireless power transmission device 21 and the electronic device 22 are in communication with each other through the first communication protocol module 211 and the second communication protocol module 2211. Then, the electric power is transmitted from the first charging protocol module 212 to the second charging protocol module 2212 in the wireless transmission manner. Then, the electric power with a predetermined voltage value (e.g., 12V) is transmitted from the power receiving module 221 to the DC converter 222. Under control of the control unit 223, the predetermined voltage value is decreased from 12V to 5V by the DC converter 222. Consequently, the electric power with the voltage value of 5V is transmitted from the DC converter 222 to the battery charging module 224 in order to charge the battery.

If the residual battery capacity of the electronic device 22 is lower than a predetermined capacity, the battery charging module 224 issues a power change request R1 to the control unit 223. According to the power change request R1, the control unit 223 controls the DC converter 222 to change the predetermined voltage value from 5V to 9V. Consequently, the electric power with the voltage value of 9V is transmitted from the DC converter 222 to the battery charging module 224 in order to charge the battery at a fast rate.

However, the conventional wireless charging system 2 still has some drawbacks. For example, since the DC converter 222 and the control unit 223 are used for decreasing the predetermined voltage value to the required voltage value, the power loss increases and the wireless charging efficiency is insufficient.

Therefore, there is a need of providing a wireless charging system with enhanced charging efficiency.

### SUMMARY OF THE INVENTION

An object of the present invention provides a wireless charging system with enhanced charging efficiency.

In accordance with an aspect of the present invention, there is provided a wireless charging system. The wireless charging system includes a wireless power transmission device and an electronic device. The wireless power transmission device outputs an electric power in a wireless transmission manner. The electronic device is placed on the wireless power transmission device to receive the electric power in the wireless transmission manner. The electronic device includes a power receiving module, a control module and a battery charging module. The power receiving module is in wireless communication with the wireless power transmission device to receive the electric power. The control module is connected with the power receiving module. The control module receives the electric power from the power receiving module and outputs the electric power. The battery charging module is connected with the control module. The battery charging module receives the electric power from the control module or issues a power change request to the control module. When the control module receives the power change request, the control module requests the wireless power transmission device to increase the electric power through the power receiving module.

In an embodiment, the wireless power transmission device includes a first communication protocol module and a first charging protocol module, the power receiving module includes a second communication protocol module and a second charging protocol module, and the control module includes a third charging protocol module and a software protocol module. The third charging protocol module is connected with the second charging protocol module and the battery charging module. The third charging protocol module receives the electric power from the second charging protocol module and transmits the electric power to the battery charging module. Alternatively, the third charging protocol module receives the power change request from the battery charging module. The software protocol module is connected with the second communication protocol module and the third charging protocol module to receive the power change request. According to the power change request, the software protocol module requests the wireless power transmission device to increase the electric power through the power receiving module.

From the above descriptions, the wireless charging system of the present invention is equipped with the software protocol module. The software protocol module is installed in the electronic device. Moreover, the software protocol module is connected with the second communication protocol module and the third charging protocol module. The software protocol module is in communication with the wireless power transmission device and the battery charging module through the second communication protocol module, the first communication protocol module and the third charging protocol module. Consequently, the operation mode of the battery charging module is switched between the ordinary charging mode and the fast charging mode. Since it is not necessary to install the DC converter in the electronic device, the layout space within the electronic device is saved. In other words, the thickness of the electronic device can be reduced.

As mentioned above, the conventional wireless power transmission device provides the electric power with the higher voltage value to the DC converter and the DC converter outputs the electric power with the lower voltage value. Consequently, the power loss of the conventional wireless charging system is larger. In accordance with the wireless charging system of the present invention, the wireless power transmission device provides required electric power to the electronic device according to the instructions of the software protocol module. Since the electric power is not converted by the electronic device, the power loss is largely reduced. In other words, the charging efficiency of the wireless charging system of the present invention is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional wireless charging system;

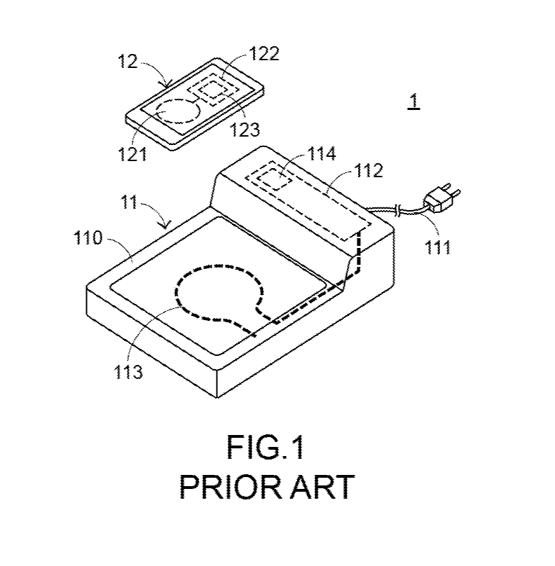

FIG. 2 is a functional block diagram illustrating the architecture of a conventional wireless charging system with a fast charging function; and

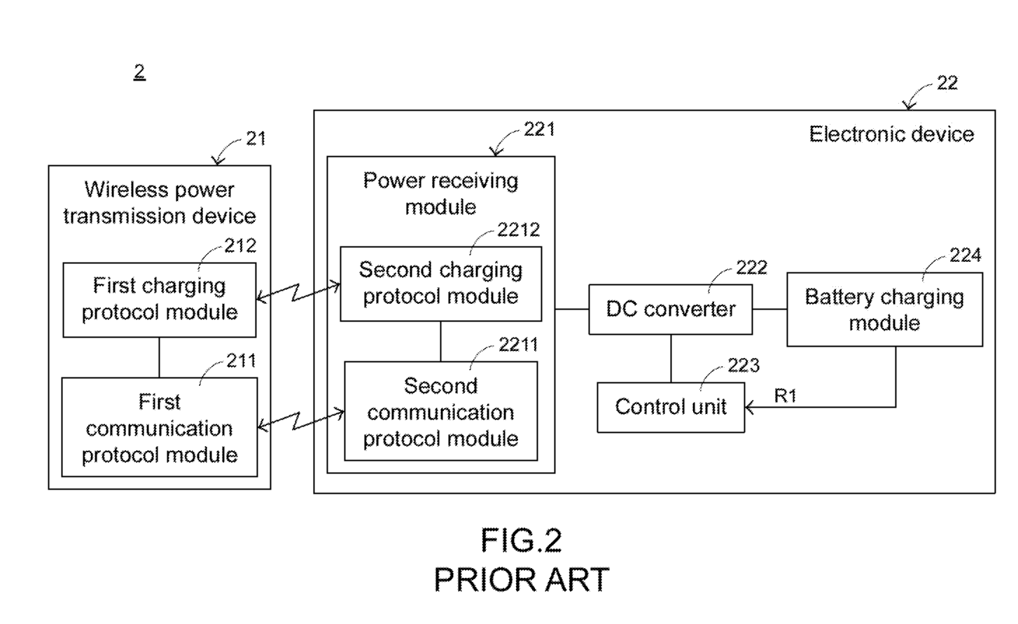

FIG. 3 is a functional block diagram illustrating the architecture of a wireless charging system according to an embodiment of the present invention.

### DETAILED DESCRIPTION OF THE PREFERRED EMBODIMENT

For eliminating the drawbacks of the conventional technologies, the present invention provides a wireless charging system.

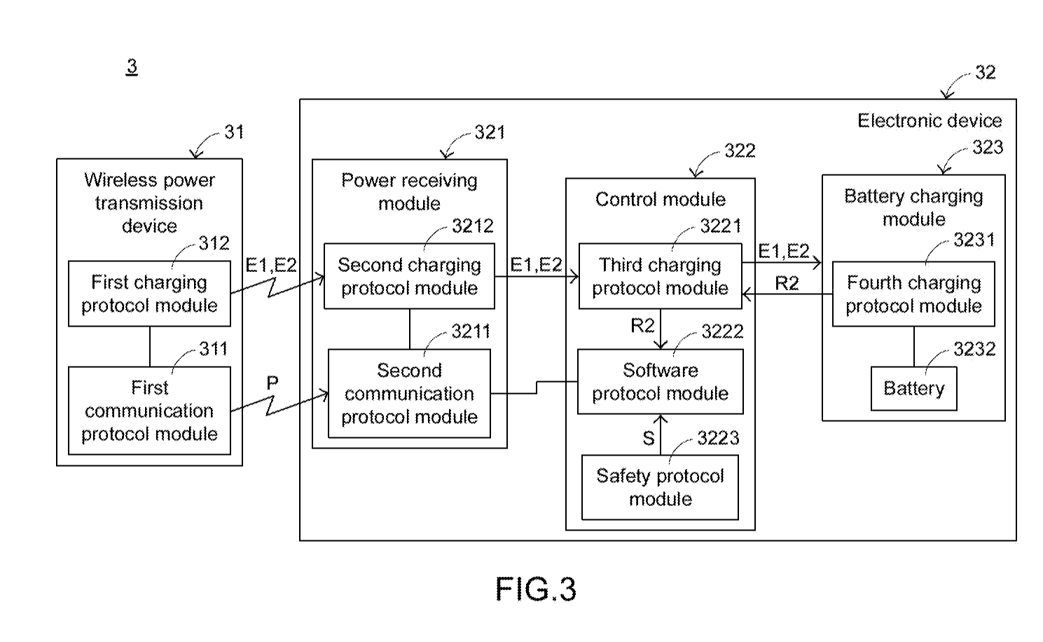

FIG. 3 is a functional block diagram illustrating the architecture of a wireless charging system according to an embodiment of the present invention. As shown in FIG. 3, the wireless charging system 3 comprises a wireless power transmission device 31 and an electronic device 32.

When the wireless power transmission device 31 is connected with a power source (not shown), the wireless power transmission device 31 is enabled. The wireless power transmission device 31 can detect the electronic device 32. After the wireless connection between the wireless power transmission device 31 and the electronic device 32 is established, the wireless power transmission device 31 outputs electric power in a wireless transmission manner. The wireless power transmission device 31 comprises a first communication protocol module 311 and a first charging protocol module 312. The first communication protocol module 311 is in wireless communication with the electronic device 32. The first communication protocol module 311 has two functions. In accordance with a first function, the first communication protocol module 311 periodically issues a detecting signal P at a predetermined time interval so as to detect the electronic device 32. In accordance with a second function, the first communication protocol module 311 is used for communicating with the electronic device 32. The first charging protocol module 312 is connected with the first communication protocol module 311. After the first communication protocol module 311 is in communication with the electronic device 32, the electric power E1 is transmitted from the first charging protocol module 312 to the electronic device 32 in the wireless transmission manner. Preferably, the way of transmitting the electric power from the first charging protocol module 312 may be altered according to the practical requirements. The first charging protocol module 312 comprises a transmitter coil (not shown).

Moreover, the electronic device 32 is placed on the wireless power transmission device 31 or located near the wireless power transmission device 31. That is, the electronic device 32 is located within a wireless charging range of the wireless power transmission device 31. Consequently, the electronic device 32 receives the electric power E1 from the wireless power transmission device 31 in the wireless transmission manner.

The electronic device 32 comprises a power receiving module 321, a control module 322 and a battery charging module 323. The power receiving module 321 is in wireless communication with the wireless power transmission device 31. Moreover, the power receiving module 321 receives the electric power E1 in the wireless transmission manner. The control module 322 is connected with the power receiving module 321 for receiving the electric power E1 from the power receiving module 321 and transmitting the electric power to the battery charging module 323. Moreover, according to a request from the battery charging module 323, the control module 322 performs a corresponding operation. The operation will be described later.

The battery charging module 323 is connected with the control module 322. The battery charging module 323 is used for receiving the electric power E1 from the control module 322 or issuing a power change request R2 to the control module. When the control module 322 receives the power change request R2, the control module 322 request the wireless power transmission device 31 to increase the electric power from E1 to E2 through the power receiving module 321. Consequently, the fast charging purpose is achieved. An example of the electronic device 32 includes but is not limited to a smart phone, a tablet computer, a personal digital assistant or a handheld game console.

The inner structure of the electronic device 32 will be described as follows. The power receiving module 321 comprises a second communication protocol module 3211 and a second charging protocol module 3212. The second communication protocol module 3211 is in wireless communication with the first communication protocol module 311 of the wireless power transmission device 31. After the second communication protocol module 3211 receives the detecting signal P, the wireless connection between the second communication protocol module 3211 and the first communication protocol module 311 is established. The second charging protocol module 3212 is connected with the second communication protocol module 3211. Moreover, the second charging protocol module 3212 is in wireless communication with the first charging protocol module 312. Consequently, the second charging protocol module 3212 receives the electric power E1 from the first charging protocol module 312 in the wireless transmission manner. Moreover, the second charging protocol module 3212 comprises a receiver coil (not shown) for receiving the electric power E1 from the transmitter coil. Of course, the second charging protocol module 3212 also receives the dynamically-changed electric power from the first charging protocol module 312. In an embodiment, the power receiving module 321 is a microprocessor or a power receiving IC.

As shown in FIG. 3, the control module 322 comprises a third charging protocol module 3221, a software protocol module 3222 and a safety protocol module 3223. The third charging protocol module 3221 is connected with the second charging protocol module 3212 and the battery charging module 323. In an embodiment, the third charging protocol module 3221 receives the electric energy E1 from the second charging protocol module 3212 and controls whether the electric power E1 is transmitted to the battery charging module 323 or not. In another embodiment, the third charging protocol module 3221 receives the power change request R2 from the battery charging module 323. The software protocol module 3222 is connected with the second communication protocol module 3211, the third charging protocol module 3221 and the battery charging module 323. The software protocol module 3222 receives the power change request R2. According to the power change request R2, the software protocol module 3222 requests the wireless power transmission device 31 to increase the electric power from E1 to E2. The software protocol module 3222 further provides other functions, which will be described later. The safety protocol module 3223 is connected with the software protocol module 3222 and the power receiving module 321. For succinctness, the connection between the safety protocol module 3223 and the power receiving module 321 is not shown in the drawing. The safety protocol module 3223 is used for monitoring the safety statuses of the power receiving module 321 and the control module 322. If the safety status of the power receiving module 321 or the safety status of control module 322 is abnormal (e.g., in the over-voltage condition, the over-current condition or the over-temperature condition), the safety protocol module 3223 issues a warning signal S to the software protocol module 3222 and stops transmitting the electric power E1 to the battery charging module 323. In an embodiment, the control module 322 is a microprocessor.

The battery charging module 323 comprises a fourth charging protocol module 3231 and a battery 3232. The fourth charging protocol module 3231 is connected with the third charging protocol module 3221. The fourth charging protocol module 3231 has the following two functions. In accordance with the first function, the fourth charging protocol module 3231 is used for receiving the electric power E1 from the third charging protocol module 3221 and transmitting the electric power E1 to the battery 3232 of the battery charging module 323. In accordance with the second function, the fourth charging protocol module 3231 judges whether the battery charging module 323 has to perform a fast charging operation or not. The battery 3232 is connected with the fourth charging protocol module 3231. Moreover, the battery 3232 receives the electric power E1 from the fourth charging protocol module 3231. After the fourth charging protocol module 3231 receives the electric power E1, the fourth charging protocol module 3231 judges whether the fast charging operation is required. According to the residual battery capacity or the withstand electric power, the fourth charging protocol module 3231 judges whether the battery charging module 323 has to perform the fast charging operation or not.

For example, if the residual capacity of the battery 3232 is lower than the predetermined capacity, the fourth charging protocol module 3231 judges that the residual capacity of the battery 3232 is too low and the fast charging operation has to be performed. Meanwhile, the fourth charging protocol module 3231 issues the power change request R2 to the third charging protocol module 3221 of the control module 322, and the third charging protocol module 3221 transmits the power change request R2 to the software protocol module 3222. The way of judging whether the battery charging module 323 has to perform the fast charging operation is presented herein for purpose of illustration and description only. In another embodiment, if the withstand electric power of the battery charging module (e.g., 9V) is higher than the electric power from the wireless power transmission device, the fourth charging protocol module judges that the fast charging operation has to be performed and the fourth charging protocol module issues the power change request to the control module.

The operations of the wireless charging system 3 will be described as follows. After the wireless power transmission device 31 is enabled, the first communication protocol module 311 periodically issues the detecting signal P at a predetermined time interval (e.g., 200 milliseconds) so as to detect whether the electronic device 32 is located near the wireless power transmission device 31. When the electronic device 32 is placed on the wireless power transmission device 31, the second communication protocol module 3211 of the power receiving module 321 receives the detecting signal P. Consequently, the wireless connection between the second communication protocol module 3211 and the first communication protocol module 311 is established. Meanwhile, the second communication protocol module 3211 and the first communication protocol module 311 are in communication with each other. The communication between these two communication protocol modules is well known to those skilled in the art, and is not redundantly described herein. After the first communication protocol module 311 and the second communication protocol module 3211 are in communication with each other, the power receiving module 321 is enabled. In addition, the first communication protocol module 311 notifies the first charging protocol module 312 that the wireless charging operation is ready. Consequently, the electric power E1 with the predetermined voltage value (e.g., 5V) is transmitted from the first charging protocol module 312 to the electronic device 32.

After the second charging protocol module 3212 of the power receiving module 321 in the electronic device 32 receives the electric power E1 with the predetermined voltage value, the software protocol module 3222 monitors whether the electric power E1 is stable through the third charging protocol module 3221 and the second charging protocol module 3212. If the software protocol module 3222 judges that the electric power E1 is stable, the software protocol module 3222 allows the electric power E1 to be transmitted to the battery charging module 323. Whereas, if the software protocol module 3222 judges that the electric power E1 is not stable, the software protocol module 3222 continuously monitors the electric power E1 until the electric power E1 is stable. After the electric power E1 with the predetermined voltage value is stable and transmitted to the third charging protocol module 3221, the electric power E1 with the predetermined voltage value is transmitted from the third charging protocol module 3221 to the battery charging module 323 through the fourth charging protocol module 3231. Consequently, an ordinary charging operation is performed. In the above process, the safety protocol module 3223 continuously monitors whether the safety statuses of the power receiving module 321 and the control module 322 are abnormal.

After the battery charging module 323 receives the electric power E1 with the predetermined voltage value, the fourth charging protocol module 3231 judges whether the battery charging module 323 has to perform the fast charging operation according to the residual battery capacity or the withstand electric power of the battery charging module 323. If the fourth charging protocol module 3231 judges that the fast charging operation has to be performed, the fourth charging protocol module 3231 issues the power change request R2 to the software protocol module 3222 of the control module 322 through the third charging protocol module 3221. If the software protocol module 3222 does not receive the warning signal S from the safety protocol module 3223, the software protocol module 3222 requests the wireless power transmission device 31 to increase the electric power through the second communication protocol module 3211 and the first communication protocol module 311 according to the power change request R2.

According to the request from the software protocol module 3222, the wireless power transmission device 31 realizes the required voltage value (e.g., 9V) of the battery charging module 323 through the communication between the first communication protocol module 311 and the second communication protocol module 3211. Consequently, the electric power E2 with the required voltage value is transmitted from the wireless power transmission device 31 to the electronic device 32 through the first charging protocol module 312 and the second charging protocol module 3212. After the electric power E2 is transmitted to the electronic device 32, the electric power E2 is transmitted to the battery charging module 323 through the third charging protocol module 3221 and the fourth charging protocol module 3231 sequentially. Consequently, the fast charging operation is performed.

The following two aspects should be specially described. Firstly, the safety protocol module 3223 monitors the safety statuses of the power receiving module 321 and the control module 322 in the whole course after the power receiving module 321 is enabled. Moreover, if the safety protocol module 3223 judges that the safety status of the power receiving module 321 or the safety status of the control module 322 is abnormal, the safety protocol module 3223 issues the warning signal S to the software protocol module 3222. When the software protocol module 3222 receives the warning signal S, the software protocol module 3222 controls the third charging protocol module 3221 to stop transmitting the electric power to the battery charging module 323, and the software protocol module 3222 requests the wireless power transmission device 31 to stop outputting the electric power through the second communication protocol module 3211 and the first communication protocol module 311. Consequently, the battery charging module 323, the power receiving module 321 and the control module 322 are protected. Secondly, if the fourth charging protocol module 3231 judges that the fast charging operation increases the residual capacity of the battery 3232 to a predetermined target capacity (e.g., 80% of the maximum capacity), the fourth charging protocol module 3231 notifies the software protocol module 3222 through the third charging protocol module 3221. Moreover, the software protocol module 3222 notifies the wireless power transmission device 31 to decrease the electric power from E2 to E1 through the first communication protocol module 311 and the second communication protocol module 3211. Consequently, the operation mode of the wireless charging system 3 is switched from the fast charging mode to the ordinary charging mode.

From the above descriptions, the wireless charging system of the present invention is equipped with the software protocol module. The software protocol module is installed in the electronic device. Moreover, the software protocol module is connected with the second communication protocol module and the third charging protocol module. The software protocol module is in communication with the wireless power transmission device and the battery charging module through the second communication protocol module, the first communication protocol module and the third charging protocol module. Consequently, the operation mode of the wireless charging system is switched between the ordinary charging mode and the fast charging mode. Since it is not necessary to install the DC converter in the electronic device, the layout space within the electronic device is saved. In other words, the thickness of the electronic device can be reduced.

As mentioned above, the conventional wireless power transmission device provides the electric power with the higher voltage value (e.g., 12V) to the DC converter and the DC converter outputs the electric power with the lower voltage value (e.g., 5V). Consequently, the power loss of the conventional wireless charging system is larger. In accordance with the wireless charging system of the present invention, the wireless power transmission device provides required electric power to the electronic device according to the instructions of the software protocol module. Since the electric power is not converted by the electronic device, the power loss is largely reduced. In other words, the charging efficiency of the wireless charging system of the present invention is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wireless charging system, comprising:
a wireless power transmission device outputting an electric power in a wireless transmission manner; and
an electronic device placed on the wireless power transmission device, and receiving the electric power in the wireless transmission manner, wherein the electronic device comprises:
a power receiving module in wireless communication with the wireless power transmission device to receive the electric power;
a control module connected with the power receiving module, wherein the control module receives the electric power from the power receiving module and outputs the electric power; and
a battery charging module connected with the control module, wherein the battery charging module receives the electric power from the control module or issues a power change request to the control module, wherein when the control module receives the power change request, the control module requests the wireless power transmission device to increase the electric power through the power receiving module.

2. The wireless charging system according to claim 1, wherein the wireless power transmission device comprises:
a first communication protocol module in wireless communication with the electronic device, wherein the first communication protocol module communicates with the power receiving module or periodically issues a detecting signal at a predetermined time interval; and
a first charging protocol module connected with the first communication protocol module, wherein the electric power is transmitted from the first charging protocol module to the power receiving module in the wireless transmission manner.

3. The wireless charging system according to claim 2, wherein the power receiving module comprises:
a second communication protocol module in wireless communication with the wireless power transmission device, wherein after the second communication protocol module receives the detecting signal, a wireless connection between the second communication protocol module and the first communication protocol module is established; and
a second charging protocol module in wireless communication with the first charging protocol module, wherein the second charging protocol module receives the first charging protocol module from the first charging protocol module in the wireless transmission manner.

4. The wireless charging system according to claim 3, wherein the control module comprises:
a third charging protocol module connected with the second charging protocol module and the battery charging module, wherein the third charging protocol module receives the electric power from the second charging protocol module and transmits the electric power to the battery charging module, or the third charging protocol module receives the power change request from the battery charging module; and
a software protocol module connected with the second communication protocol module and the third charging protocol module, and receiving the power change request, wherein the software protocol module requests the wireless power transmission device to increase the electric power through the power receiving module according to the power change request.

5. The wireless charging system according to claim 4, wherein the battery charging module comprises:
a fourth charging protocol module connected with the third charging protocol module, and receiving the electric power from the third charging protocol module; and
a battery connected with the fourth charging protocol module to receive the electric power from the fourth charging protocol module, wherein after the fourth charging protocol module receives the electric power, the fourth charging protocol module judges whether the battery charging module has to perform a fast charging operation or not.

6. The wireless charging system according to claim 5, wherein if a residual capacity of the battery is lower than a predetermined capacity, the fourth charging protocol module judges that the battery charging module has to perform the fast charging operation, and the fourth charging protocol module issues the power change request to the control module.

7. The wireless charging system according to claim 5, wherein if a withstand electric power of the battery is higher than the electric power, the fourth charging protocol module judges that the battery charging module has to perform the fast charging operation, and the fourth charging protocol module issues the power change request to the control module.

8. The wireless charging system according to claim 4, wherein the control module further comprises a safety protocol module, and the safety protocol module is connected with the software protocol module and the power receiving module to monitor a safety status of the power receiving module and a safety status of the control module, wherein if the safety status of the power receiving module or the safety status of the control module is abnormal, the safety protocol module issues a warning signal to the software protocol module.

9. The wireless charging system according to claim 8, wherein when the software protocol module receives the warning signal, the software protocol module controls the third charging protocol module to stop transmitting the electric power to the battery charging module and the battery charging module stops receiving the electric power, and the software protocol module requests the wireless power transmission device to stop outputting the electric power through the second communication protocol module and the first communication protocol module.
